(19) United States
(12) Patent Application Publication
(10) Pub. No.: US 2012/0315772 A1
(43) Pub. Date: Dec. 13, 2012

(54) SOLDERLESS CONNECTOR FOR MICROELECTRONICS

(75) Inventor: Thomas Joschika, Brædstrup (DK)

(73) Assignee: ESTRON A/S, Them (DK)

(21) Appl. No.: 13/578,452

(22) PCT Filed: Feb. 25, 2010
(86) PCT No.: PCT/DK2010/000025

§ 371 Date: Aug. 10, 2012

(51) Int. Cl. H01R 13/60; H01R 12/71

(52) U.S. Cl. 439/55; 439/346

(57) ABSTRACT

The invention relates to a micro-electrical connector for creating an electrical contact between a first and a second contact surface, said micro-electrical connector comprising at least one flexible contact, such as a polymer contact, a housing for holding said at least one flexible contact, where said housing is adapted for being positioned between said first and said second contact surface, and a fixating mean fastened to said housing in such a way that said fixation mean can be moved from a locked position to an un-locked position, wherein in said locked position said fixation mean locks said at least one flexible contact, between said first and said second, contact surface, whereby an electrical contact between said first and said second contact surface is created and in said un-locked position, at least part of said micro-electrical connector can be disassembled.

The invention relates to a micro-electrical connector for creating an electrical contact between contact points on a first and a second contact surface.

### BACKGROUND

Soldering is a widely used tool to electrically connect the different components found today in microelectronics such as hearing devices, mobile phones, medical electronic devices and such. Though soldering is an effective way of electrically connecting the different components and/or electrical contact surfaces, there is a high risk of damaging these due to the heat in the soldering process.

Also, using soldering as a way to connect different components makes repair and exchange of individual parts difficult if not impossible. Often it will be necessary to replace multiple parts during repair even though only one individual component is damaged. This makes the process unnecessarily expensive, in particular if a component, which needs to be changed frequently, is soldered to a much more expensive component, which would normally only need to be replaced on a much less frequent basis.

Further, if some of the components are heat sensitive, the soldering process might damage these components to some degree. The damaging degree might still enable the components to work, however a more frequent change may be necessary. Again this makes the process unnecessarily expensive.

The result of each individual soldering will always vary slightly. Consequently, it will be nearly impossible to obtain e.g. an even height of two or more elements soldered on row. This can be problematic if these objects are all to be brought in contact with e.g. the same planar contact surface.

The above mentioned problems are therefore especially relevant in connection with microelectronics and separate electrical connections between multiple contact points on a first and a second surface.

For some devices containing microelectronics there is a need for some of the components to be individually adjusted to the user, while for others this need is not there. E.g. in hearing devices, some of the components need to be adjusted according to the ear in which the user is wearing the device, while other components require no such adjustment. If soldering is used to connect the components that need individual adjustment to those that do not, the manufacturers are required to produce multiple sets of components soldered together instead of only producing multiple versions of the components that need to be adjusted individually.

As an alternative to soldering, polymeric contacts have been used as described in US2008187157, US20090074218, and WO2009049619. These polymer contacts are ‘activated’ when pressure is applied to them, thereby allowing a current to run from a component on one side of the polymer contact to another placed on the other side. However, no common solution has been developed, which allows for various components to be electronically connected for an easy attachment/detachment of the component, and/or which can further be used generally in diverse microelectronics ranging from hearing devices to mobile phones. Further, the prior art solution requires ingenuity when the different micro-components are to be dissembled during e.g. repair, as the small parts are difficult to get a hold on in the assembly position without using additional tools, and they are further easily scattered after being dissembled.

### DESCRIPTION OF THE INVENTION

Disclosed herein is a micro-electrical connector for creating an electrical contact between a first and a second contact surface, said micro-electrical connector comprising at least one polymer contact, a housing for holding said at least one flexible contact, such as a polymer contact, where said housing is adapted for being positioned between said first and said second contact surface, and a fixating mean fastened to said housing in such a way that said fixation mean can be moved from a locked position to an un-locked position.

In said locked position, said fixation mean locks said at least one polymer contact between said first and said second contact surface, whereby an electrical contact between said first and said second contact surface is created, and in said un-locked position, at least part of said micro-electrical connector can be disassembled. The contact surfaces can be any type of conductor used in micro-electronics, such as e.g. a receiver, a microphone, a set of wires, a PCB or similar.

The use of a flexible contact is highly advantageous, as it obviates the need for soldering when connecting the different contact surfaces, whereby the components cannot be damaged by heat in the soldering process. Further, since the two contact surfaces are not soldered together it is not necessary to replace both of them during repair, if only one of the surfaces is damaged. This reduces the prize on repair significantly.

Using a housing for holding the flexible contact is also advantageous as it secures the position of the flexible contact such that it cannot move out of position when the fixation mean is in the locked position. Further, as the fixation mean is fastened to the housing such that it can easily be turned from the locked to the un-locked position and back again, it enables easy dissembling and assembling of the micro-electrical connector. This is advantageous during repair, where e.g. one of the contact surfaces and/or the flexible contact needs to be replaced. The fastening of the fixation mean to the housing in both the locked and the un-locked position further ensures that the different micro-sized parts do not get lost during repair. The easy accessibility of the fixation mean additionally obviates the need for additional tools to e.g. remove it during repair as is commonly the case in the prior art solutions.

In one or more embodiments said housing is fixating said at least one flexible contact relative to said first and said second contact surface in said locked position, thereby ensuring that the flexible contact does not move during use of the micro-electrical connector.

In one or more embodiments said fixation mean is exerting a pressure on said first contact surface in said locked position. This is advantageous as it ensures that a current can easily run between the contact surfaces.

In one or more embodiments said fixation mean has a shape adapted to interlock with said first contact surface in said locked position, thereby ensuring a secure holding of the fixation mean in the locked position.

In one or more embodiments said fixation mean is a bracket, which is advantageous as it does not cover the entire surface of the contact surface and thereby allows for the first contact surface to be in connected to other elements.

In one or more embodiments said fixating mean is detachably connected to said housing. This allows for an easy replacement of the fixation mean if it needs repair. Also, different types and/shapes of fixation means can be easily interchanged if needed. This is advantageous if e.g. one wants to keep the same housing, flexible contact and second contact surface, but change the first contact surface to one of a different shape, which is fixated in the best way by using a differently shaped fixation mean.

In one or more embodiments said housing is adapted for containing two or more flexible contacts, whereby the micro-electrical connector can connect multiple sets of contact surfaces using the same housing.

In one or more embodiments said micro-electrical connector further comprises a back plate adapted to be attached to said housing such that said second contact surface is positioned between said housing and said back plate. This protects and stabilises the second contact surface.

In one or more embodiments said micro-electrical connector further comprises a top housing adapted to be positioned between said fixation mean and said first contact surface in said locked position. This is advantageous if the first contact surface is fragile, as the top housing can provide an additional protection to the first contact surface. Further, if the first contact surface consists of smaller component the top housing can ensure that they are all equally pressed against the flexible contact while still using only one fixation mean.

In one or more embodiments said first contact surface is a receiver, a microphone or a set of multiple electrical wires, such as e.g. six wires.

In one or more embodiments said second contact surface is a PCB.

The invention also relates to a hearing device comprising at least one micro-electrical connector according to at least one of the above described embodiments.

### BRIEF DESCRIPTION OF THE DRAWINGS

FIGS. 1a and b show one embodiment of the invention in which a polymer contact is used to electrically connect a printed circuit board (PCB) and a receiver.

FIGS. 2a and b show one embodiment of the invention in which a polymer contact is used to electrically connect a PCB and a microphone.

FIGS. 3a and b show one embodiment of the invention in which a polymer contact is used to electrically connect a PCB and set of wires.

FIG. 4a and b show an alternative embodiment where the flexible contact has been made using electrically conductive springs.

### DESCRIPTION OF PREFERRED EMBODIMENTS

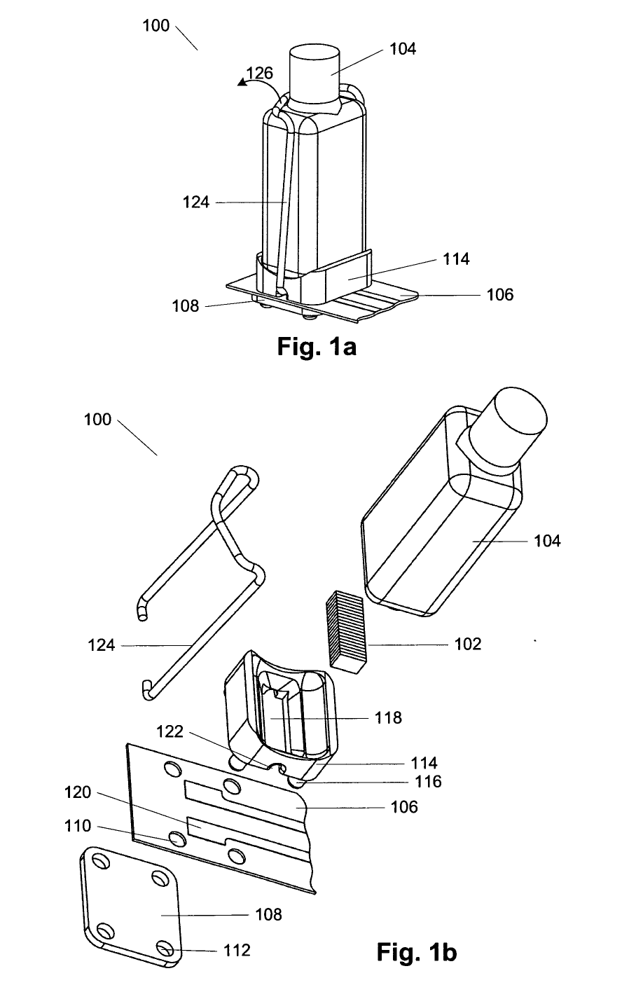

The flexible contact 102 shown in the FIGS. 1a-b, 2a-b and 3a-b is a polymer contact which comprises alternating layers of conducting and non-conducting materials. It exhibits a high resistance (insulating performance) when it is not pressed/squeezed/pinched in between two components. As the polymer contact 102 is pressed in between two components, electrical contact between the components is obtained through the polymer contact.

The polymer contact 102 could for instance be produced as described in U.S. Pat. No. 5,175,214 incorporated herein by reference or could e.g. be the Zebra® Carbon, Zebra® Silver, Zebra® Gold elastomers from Fujipoly® or other conductive elastomers provided by Shin-Etsu Polymer. Such a contact comprises layers of an electrical isolating material whereby separate electrical contact can be made through a single piece of polymer.

FIGS. 1a and b show one embodiment of the solderless micro-electrical connector according to the invention wherein the polymer contact 102 electrically connects a receiver 104 with a PCB 106. Thereby contact points on the receiver surface are being electrically connected with contact points on the PCB surface. Further, if the polymer contact is a contact comprising layers of isolating material as described above, then separate electrical connections between contact points on the respective surfaces can be obtained.

The receiver 104 could e.g. be used in a hearing device where it would be placed within or near the ear channel. FIG. 1a shows the different components of the solderless connector 100 in an assembly state, while FIG. 1b is an exploded view.

The solderless micro-electrical connector 100 comprises a back plate 108 situated underneath the PCB 106. The back plate 108 is normally a metal plate providing a high stability to the PCB 106. Alternatively, plastic can be used instead of metal. Both the back plate 108 and the PCB 106 are equipped with smaller openings 110, 112 of a similar size. These are placed on top of one another in the assembly phase.

The solderless micro-electrical connector 100 further comprises a housing 114 found on top of the PCB 106. On the bottom side of the housing 114, a set of rivets 116 are situated. Both the housing 114 and the rivets 116 are normally made in plastic, but can as an alternative also be made in metal. The rivets 116 fit into the openings 110, 112 in the PCB 106 and the back plate 108. Fewer or more than the displayed four rivets 116 and corresponding holes 110, 112 in the PCB 106 and the back plate 108 may also occur. Normally, the number of openings 110, 112 and the number of rivets 116 are the same. The back plate 108 and/or the PCB 106 may also have additional openings, as long as there is a matching opening in both for each rivet 116.

By heating the rivets 116 after they have been directed through the openings 110, 112, the plastic deforms due to the heat, thereby forming a locking mechanism which firmly secures the back plate 108, the PCB 106 and the housing 114 together. The heating is applied on the bottom side of the back plate 108, which is not in contact with the PCB 106, and the latter is therefore not affected by the heating.

The housing 114 is shaped such that the polymer contact 102 fits inside it. On the bottom of the housing 114 is an opening 118, which allows for a direct contact between the polymer contact 102 and the contact points 120 of the PCB 106.

At the bottom side of the housing 114, a set of grooves 122 allows for attachment of a bracket 124 on to the housing 114. The bracket 124 fastens the receiver 104 to the housing upon assembly thereby ensuring that the polymer contact 102 is squeezed/pinched in between the receiver 104 and the PCB 106. This creates an electrical connection between the receiver 104 and the PCB 106 allowing current to flow from one to the other.

By flipping the bracket 124 between the locked position shown in FIG. 1a to an un-locked position as indicated by the arrow 126, the different components can easily be disassembled again thereby allowing an easy replacement of the receiver 104, the polymer contact 102 and/or the PCB 106 with the housing 114. The size and the shape of this bracket 124 can vary depending on the object which it is to fasten to the housing 114. Hence, differently sized/shaped brackets can easily be interchanged.

Instead of a bracket which is inserted into grooves in the housing, other fixation means can be used. Instead of one bracket attached to opposite sides of the housing 114, two separate pins—one attached to each of the opposite sides of the housing 114—could be employed to grasp the top of the receiver 104, thereby pressing it against the polymer contact 102. A housing with a type of a lid enclosing the receiver could be another alternative way of securing the receiver 104 in the housing 114, thereby pressing it against the polymer contact 102. Yet another way of securing the receiver 104 in the housing 114 could be by means of using another type of housing, which is longer than the receiver 104. At the top part of the long housing reaching over the receiver, at least two holes present could allow for insertion of a locking member. This locking member would secure the receiver 104 in the housing 114, and be placed at a height allowing it to press the receiver 104, the polymer contact 102 and the PCB 106 together.

As an alternative to the square shape of the housing 114 shown in FIG. 1, alternative shapes may also occur as long as the polymer contact 102 and part of the receiver 104 (or alternatively a different electrical element as displayed in the following figures) are secured firmly inside the housing 114.

In one embodiment of the invention, the housing 114 and the bracket 124 are made in plastic. Embodiments where only the housing 114 or parts of it are made in plastic can equally well be used. The other parts can be made in another material such as metal.

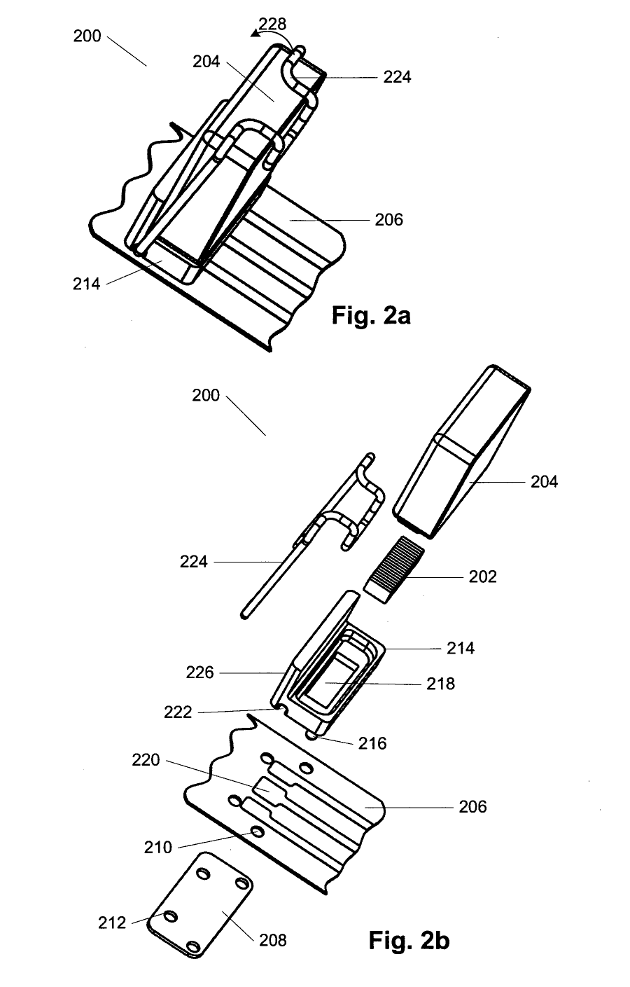

FIG. 2a with the assembly state and FIG. 2b with an exploded view show one embodiment of the solderless micro-electrical connector 200 wherein a polymer contact 202 connects a microphone 204, e.g. placed behind the ear in a hearing device, with a PCB 206. The PCB 206, the housing 214 and the back plate 208 are assembled as described above for FIGS. 1a-b by heating up rivets 216 placed underneath the housing 214 after they have been guided through the openings 210 and 212 in the PCB 206 and the back plate 208, respectively.

In this embodiment of the invention, the distance between the different openings 210, 212 and the different rivets 216 are different as compared to the more symmetric placement shown in FIGS. 1a-b. Likewise, the housing 214 has an asymmetric shape with an additional support section 226 helping to secure the microphone 204 in the assembly state. Other housing shapes with e.g. two or more support sections of a similar or different shape and size may also occur.

The housing 214 has an opening 218 at the bottom, which allows the polymer contact 202 placed therein to be squeezed/pinched between the microphone 204 and the PCB 206 in the assembly position with the use of a bracket 224 securing the position of the different components. An electrical connection from the microphone 204 to the PCB 206 is thereby provided. The bracket 224 is secured in the housing 214 by inserting it in grooves 222. By flipping the bracket 224 between the locked position shown in FIG. 2a to an un-locked position as indicated by the arrow 228, the different components can easily be disassembled again thereby allowing an easy replacement of one or more of them. Like described for FIGS. 1a-b, the bracket 224 can be interchanged allowing for brackets of different sizes and shapes to be used.

Other fastening solutions like e.g. lids as described for FIGS. 1a-b may also be used. The material for the housing 214 is normally plastic, but metal may also be used as an alternative material, possibly only for parts of the housing 214.

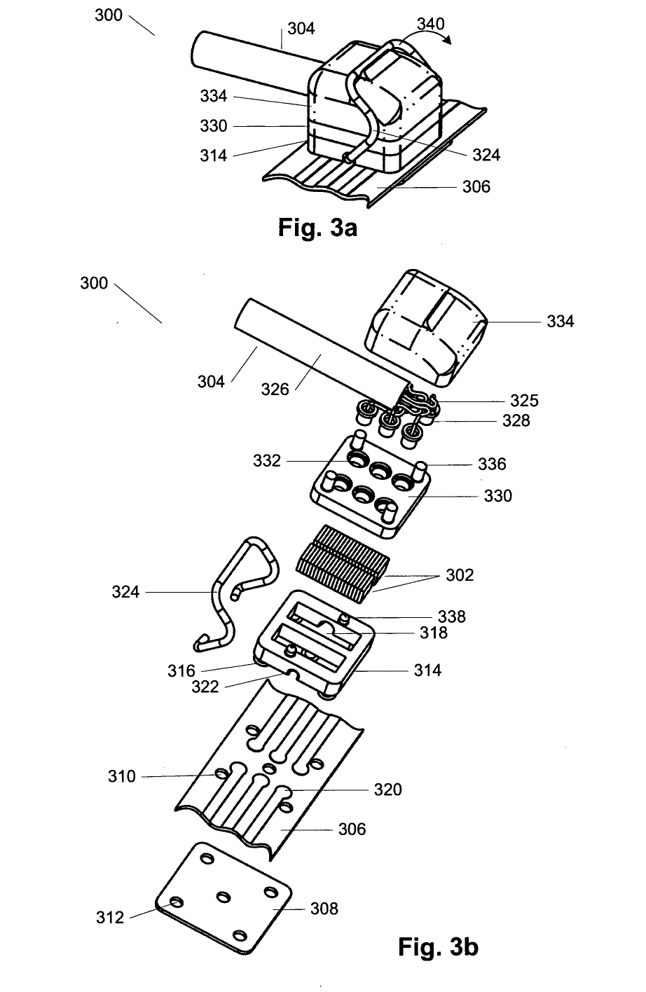

FIG. 3a with the assembly state and FIG. 3b with an exploded view show one embodiment of the solderless micro-electrical connector 300 wherein two polymer contacts 302 connect a cable 304 with a PCB 306. The cable 304 comprises an outer isolating jacket 326, which may be flexible. IN this embodiment, the isolating jacket 326 covers a set of six wires 325, but the number could be both higher and lower. The individual wires 325 are normally lacquered conducting wires, wherein the lacquer insures that the individual wires 325 are isolated thereby allowing them to be placed closely together. This is advantages in microelectronics, where size is of importance.

Each wire 325 is fastened in a contact shoe 328 by e.g. soldering, where the contact shoes 328 fit into openings 332 in a contact housing 330. This enables an easy placement of the wires 325, and further provides a way to ensure that the wires 325 are placed in the same position again upon repair/replacement of the cable 304.

A top housing 334 is placed on top of the contact housing 330 for protection of the wires 325 and the contact shoes 328 at the same time as it fixates the cable 304 in between the contact housing 330 and the top housing 334. On the bottom of the top housing 334 there is a set of openings (not shown), for receiving a set of rivets 336 placed on the top side of the contact housing 330. This ensures that the top housing 334 stays in the correct position with regard to the contact housing 330 in the assembly position. In this embodiment of the invention there are four openings/rivets 336, but both fewer and more may also be used. The contact shoes 328 are normally made of metal, e.g. with a layer of gold, which ensures a better contact resistance. The contact housing 330 and the top housing 334 are normally in plastic, but other materials such as electronically isolated metal may also be used for these components or parts of them.

The PCB 306, the housing 314 and the back plate 308 are assembled as described in FIGS. 1a-b and FIGS. 2a-b by heating of the bottom rivets 316 placed underneath the housing 314 after they have been guided through the openings 310 and 312 in the PCB 306 and the back plate 308, respectively. In this embodiment of the invention, two polymer contacts 302 are placed within the housing 314, each in their own opening 318. This also allows space for an additional bottom rivet 316 placed in the middle of the housing 314 and correspondingly additional openings 310, 312 in the PCB 306 and the back plate 308.

A set of top rivets 338 is placed on top of the housing 314. In the assembly position these top rivets 338 fit into corresponding openings (not shown) on the bottom side of the contact housing 330. The housing 314 also has grooves 322 for receiving a bracket 324. Upon securing of the bracket 324 in the assembly position, the two polymer contacts 302 are squeezed/pinched between the wires 325 contained in the contact shoes 328 and the PCB 306. This electrically connects the cable 304 with the contact points 320 on the PCB 306 through the polymer contacts 302.

By flipping the bracket 324 between the locked position shown in FIG. 1a to an un-locked position as indicated by the arrow 340, the different components can easily be disassembled again—thereby allowing an easy replacement of one or more of them. As described in FIG. 1, the bracket 324 can be interchanged allowing for brackets of different sizes and shapes to be used. Other fastening solutions like e.g. lids as described for FIGS. 1a-b may also be used. The material for the housing 314 is normally plastic, but metal may also be used as an alternative material, possibly only to parts of the housing 314.

Mounting of multiple wires, such that all are at the exact same level horizontally, is nearly impossible. Hence, not all of them can be in contact with a flat contact surface, if such were to be pressed down upon them. When using polymer contacts 302 the surface of the polymer contacts 302 accomodates the surface against which it is pressed.

As the widths of the alternating layers of conducting and non-conducting material in the polymer contacts 302 are very small, the individual wires 325 will always be in contact with typically 3-4 layers of conduction material in the polymer contact 302. Hence, if a grain of dust lays on one of the conducting layers, current can still run between the wire 325 and PCB 306 as the other layers of conducting material will still be in contact with the wire 325 due to the adaptability of the surface of the polymer contacts 302 upon pressure.

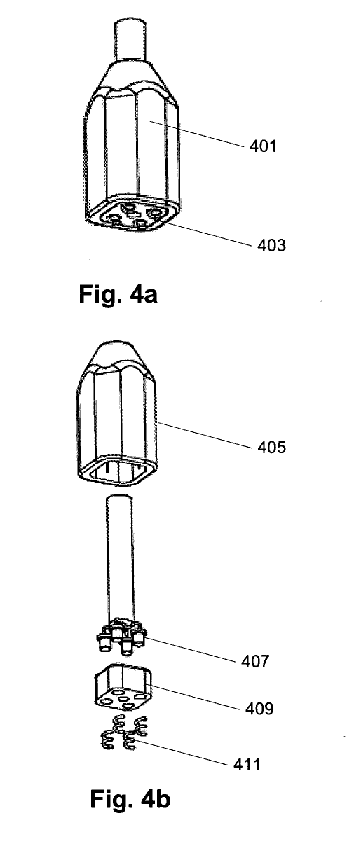

FIG. 4a and b show an alternative embodiment where the flexible contact has been made using electrically conductive springs 411. FIG. 4a with the assembly state of a receiver 401 and FIG. 4b with an exploded view of the receiver 401. The receiver comprises a receiver cover 405 and wires with an outer isolating jacket where each wire has been provided with contact shoes 407. Further, each contact shoe fits into openings in a housing 409 where electrically conductive springs 411 have been positioned.

From FIG. 4a it can be seen that a number of electrically conductive springs 403 extend through the holes of the housing in the receiver 401 and are kept in contact with the contact shoes of the wires.

The receiver can then be positioned on top of contact points of e.g. a PCB. When using this spring based contact, each spring accommodate the surface against which it is pressed and ensures independent electrical contact between contact shoe and contact point even in case of uneven contact surfaces.

### REFERENCES

100 first solderless micro-electrical connector
102 polymer contact
104 receiver
106 PCB
108 back plate
110 opening on the PCB
112 opening in the back plate
114 housing
116 rivet
118 opening at the bottom of the housing
120 contact point on the PCB
122 groove on the housing
124 bracket
126 arrow indicating the position of the bracket in the un-locked position
200 second solderless micro-electrical connector
202 polymer contact
204 microphone
206 PCB
208 back plate
210 opening on the PCB
212 opening in the back plate
214 housing
216 rivet
218 opening at the bottom of the housing
220 contact point on the PCB
222 groove on the housing
224 bracket
226 support section
228 arrow indicating the position of the bracket in the un-locked position
300 third solderless micro-electrical connector
302 polymer contact
304 cable
306 PCB
308 back plate
310 opening on the PCB
312 opening in the back plate
314 housing
316 bottom rivet on the housing
318 opening at the bottom of the housing
320 contact point on the PCB
322 groove on the housing
324 bracket
325 wire
326 outer isolating jacket
328 contact shoe
330 contact housing
332 opening in the contact housing
334 top housing
336 rivet on the contact housing
338 top rivet on the housing
340 arrow indicating the position of the bracket in the un-locked position
401 receiver
403 electrically conductive springs
405 receiver cover
407 wires with an outer isolating jacket where each wire has been provided with contact shoes
409 housing
411 an electrically conductive spring

1. A micro-electrical connector for creating an electrical contact between a first and a second contact surface comprising contact points, wherein at least one of said surfaces comprises a plurality of electrical contact points, said micro-electrical connector comprising:
at least one flexible contact;
a housing for holding said at least one flexible contact, wherein said housing is adapted for being positioned between said first and said second contact surface; and
a fixating means fastened to said housing in such a way that said fixation means can be moved from a locked position to an un-locked position,
wherein:
when moving said fixation means from an un-locked to a locked position, said fixation means squeezes/pinches said at least one flexible contact between said first and said second contact surface, whereby an electrical contact between said first and said second contact surface is created;
when moving said fixation means to an un-locked position said flexible contact is no longer squeezed/pinched between said first and second contact surface and at least part of said micro-electrical connector can be disassembled.

2. A micro-electrical connector according to claim 1, wherein said housing fixates said at least one flexible contact relative to said first and said second contact surface in said locked position.

3. A micro-electrical connector according to claim 1, wherein said fixation means exerts a pressure on said first contact surface in said locked position.

4. A micro-electrical connector according to claim 1, wherein said fixation means has a shape adapted to interlock with said first contact surface in said locked position.

5. A micro-electrical connector according to claim 1, wherein said shape of said fixation means is a bracket.

6. A micro-electrical connector according to claim 1, wherein said fixating means is detachably connected to said housing.

7. A micro-electrical connector according to claim 1, wherein said housing is adapted for containing two or more polymer contacts.

8. A micro-electrical connector according to claim 1, wherein said micro-electrical connector further comprises a back plate adapted to be attached to said housing such that said second contact surface is positioned between said housing and said back plate.

9. A micro-electrical connector according to claim 1, wherein said micro-electrical connector further comprises a top housing adapted to be positioned between said fixation means and said first contact surface in said locked position, thereby protecting said first contact surface.

10. A micro-electrical connector according to claim 1, wherein said first contact surface is a receiver.

11. A micro-electrical connector according claim 1, wherein said first contact surface is a microphone.

12. A micro-electrical connector according any claim 1, wherein said first contact surface is a set of multiple electrical wires.

13. A micro-electrical connector according to claim 1, wherein said second contact surface is a PCB.

14. A hearing device comprising at least one micro-electrical connector according to claim 1.

15. A micro-electrical connector according to claim 1, wherein the at least one flexible contact is a polymer contact.

16. A micro-electrical connector according to claim 12, wherein the set of multiple electrical wires is six electrical wires.
